(19) United States
(12) Patent Application Publication
(10) Pub. No.: US 2008/0022566 A1
(43) Pub. Date: Jan. 31, 2008

(54) Greeting, Inspirational and/or condolence quote card display system

(76) Inventors: Ann Busch, Sabetha, KS (US); Paola LeCleir, Omaha, NE (US); Mary Kay Mueller, Omaha, NE (US)

Correspondence Address: LAW OFFICES OF ADAM H. JACOBS;PATENT ATTORNEY, SUITE 726, 1904 FARNAM STREET, OMAHA, NE, 68102, US

(21) Appl. No.: 11/821,441

(22) Filed: Jun. 22, 2007

Related U.S. Application Data
(60) Provisional application No. 60/818,184, filed on Jun. 30, 2006.

(51) Int. Cl. G09F 1/10

(52) U.S. Cl. 40/124

(57) ABSTRACT

A greeting, inspirational and/or condolence quote card display system includes a single hanging hook mounted on and extending outwards from a securement device for securing the hook on an object and a plurality of generally planar cards having greeting, inspirational and/or condolence indicia printed or affixed thereon, each of the plurality of quote cards including a top central hole formed extending therethrough, the top central hole adapted to receive the hook therethrough to suspend the quote card from the hanging hook when the securement device is mounted on an object thereby displaying the printed quote card and the greeting, inspirational and/or condolence indicia printed thereon.

### CROSS-REFERENCE TO RELATED PATENTS

This application claims priority based on a provisional patent, specifically on the Provisional Patent Application Ser. No. 60/818,184 filed Jun. 30, 2006.

### BACKGROUND OF THE INVENTION

1. Technical Field

The present invention is directed to greeting, inspirational and/or condolence display devices and, more particularly, to a greeting, inspirational and/or condolence quote card display system which includes a single hanging hook mounted on and extending outwards from a securement device for securing the hook on an object and a plurality of planar cards having greeting, inspirational and/or condolence indicia printed or affixed thereon, each of the plurality of quote cards including a top central hole formed extending therethrough, the top central hole adapted to receive the hook therethrough to suspend the quote card from the hanging hook when the securement device is mounted on an object thereby displaying the printed quote card and the greeting, inspirational and/or condolence indicia printed thereon.

2. Description of the Prior Art

Greeting cards are an enormous business and are used primarily to provide handy, yet heartfelt expressions of inspiration, sympathy or caring when they are presented to other persons. While there are greeting cards for virtually any situation, unfortunately the traditional greeting card with its single message often cannot provide the desired level of personal connection necessary to truly convey the giver's message of inspiration, sympathy or caring.

One example of an event which calls for a message or gift from friends or family is when a death occurs. It becomes incumbent upon friends and family of the deceased to share an appropriate form of condolence or sympathy to family members who have sustained a loss. At present, the most common way to do this is through the use of a simple printed card of the kind sold in drug stores or supermarkets, which is soon discarded and not long after forgotten. Far better would be an ability to present a device or product which allows for recurring, prominently displayed, varied expressions of sympathy, encouragement and inspiration through a longer portion of the grief cycle. At the present time, no such device or product is available.

Therefore, an object of the present invention is to provide a greeting, inspirational and/or condolence quote card display system.

Another object of the present invention is to provide greeting, inspirational and/or condolence quote card display system which provides an easily usable display device for displaying expressions of sympathy, caring and inspiration.

Another object of the present invention is to provide greeting, inspirational and/or condolence quote card display system which can be removably mounted on household objects and fixtures for display of the quotes, such as on a refrigerator, wall or other object.

Another object of the present invention is to provide greeting, inspirational and/or condolence quote card display system which includes a variety of different quotes for different situations, any of which may be selected and quickly and easily displayed thereon.

Finally, an object of the present invention is to provide greeting, inspirational and/or condolence quote card display system which is relatively simple and durable in construction and is safe, efficient and effective in use.

### SUMMARY OF THE INVENTION

The present invention provides a greeting, inspirational and condolence quote card display system which includes a hanging hook and a hook securement device on which the hanging hook is mounted extending outwards therefrom, the hook securement device operative to releasably secure the hanging hook on a mounting object. A plurality of generally planar quote cards having a different one of at least one of greeting, inspirational and condolence message indicia displayed thereon are provided, with each of the plurality of quote cards including a top central hole formed extending therethrough, the top central hole adapted to receive the hanging hook therethrough to suspend each of the plurality of quote cards from the hanging hook upon the securement device being mounted on a mounting object. Finally, the front one of the plurality of quote cards is displayed via the hanging hook whereby the at least one of greeting, inspirational and condolence message indicia displayed thereon is visible to persons viewing the front one of the plurality of quote cards thereby providing the greeting, inspirational and/or condolence message to the viewing person.

The present invention provides numerous advantages over those sympathy, greeting and condolence cards which are currently available. For example, the sentiment expressed by a standard sympathy or greeting card is obviously selected by the giver in an attempt to empathize with the receiver of the card, but if the sentiment expressed in the card is not empathetic with the receiver, the card will not be well-received and in fact may even cause the feelings of the receiver to be hurt even more. With the present invention, however, since there are numerous different sympathy, greeting and condolence messages, each being displayed on one of the plurality of quote cards, the giver may select the general area of the messages to be delivered, but the receiver may select the specific message to be displayed on the front quote card, and the message selected will thus have far more personal meaning for the receiver thus making the gift of the present invention that much more meaningful and thoughtful for the receiver of the present invention. Furthermore, because the present invention provides an easily removable mounting device for the quote cards, the cards may be displayed on many different mounting objects without causing damage to the mounting object, and therefore the user may display the quote cards in an often-viewed desirable location, such as on a refrigerator or microwave oven. Finally, because the cards of the present invention can be used to communicate many different messages, many of the subtle aspects of grief, love, loss and other emotions may be more accurately and compassionately communicated through use of the quote cards of the present invention than through the use of other presently available condolence communication devices. It is thus seen that the present invention provides a substantial improvement over those devices and systems found in the prior art.

### BRIEF DESCRIPTION OF THE DRAWINGS

FIG. 1 is a perspective view of the greeting, inspirational and/or condolence quote card display system of the present invention mounted on a refrigerator for display thereof;

FIG. 2 is a perspective view of the present invention within its sale package;

FIG. 3 is an exploded perspective view of the various elements of the greeting, inspirational and/or condolence quote card display system of the present invention; and

FIG. 4 is a detailed perspective view of the present invention showing a single quote card being displayed for viewing of the indicia thereon.

### DESCRIPTION OF THE PREFERRED EMBODIMENT

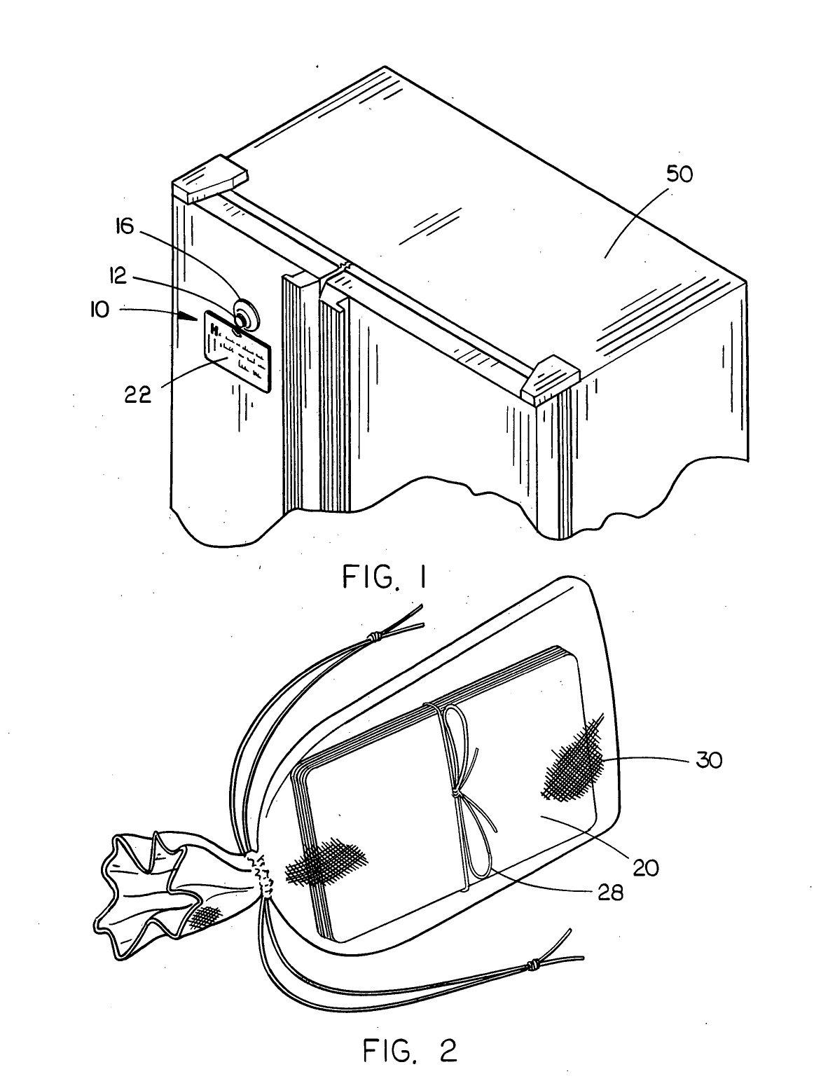

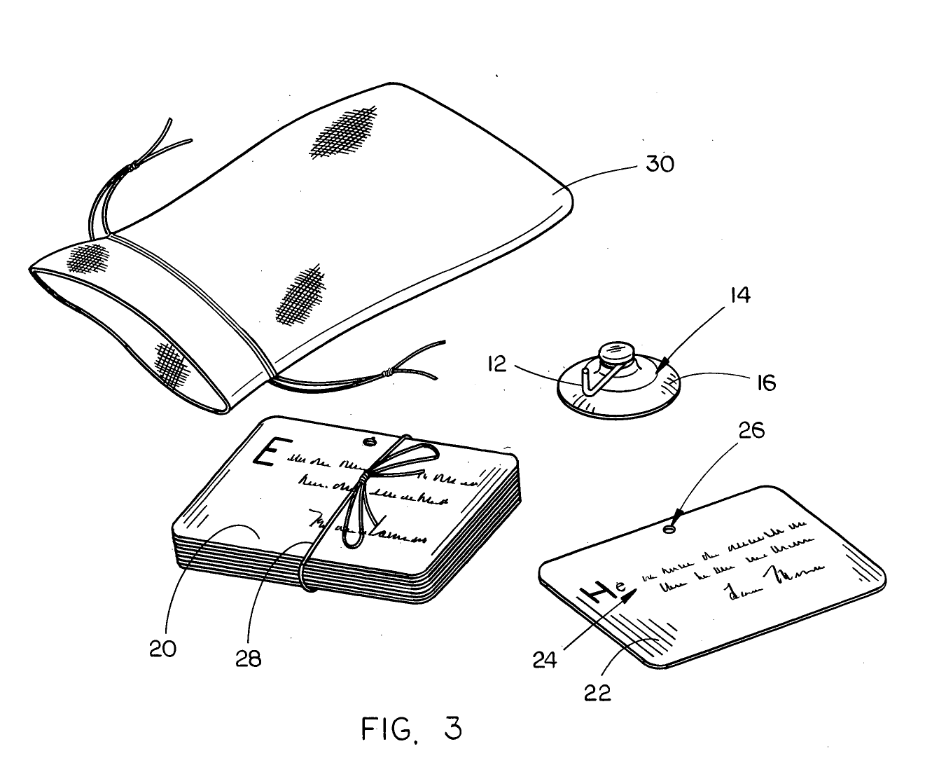

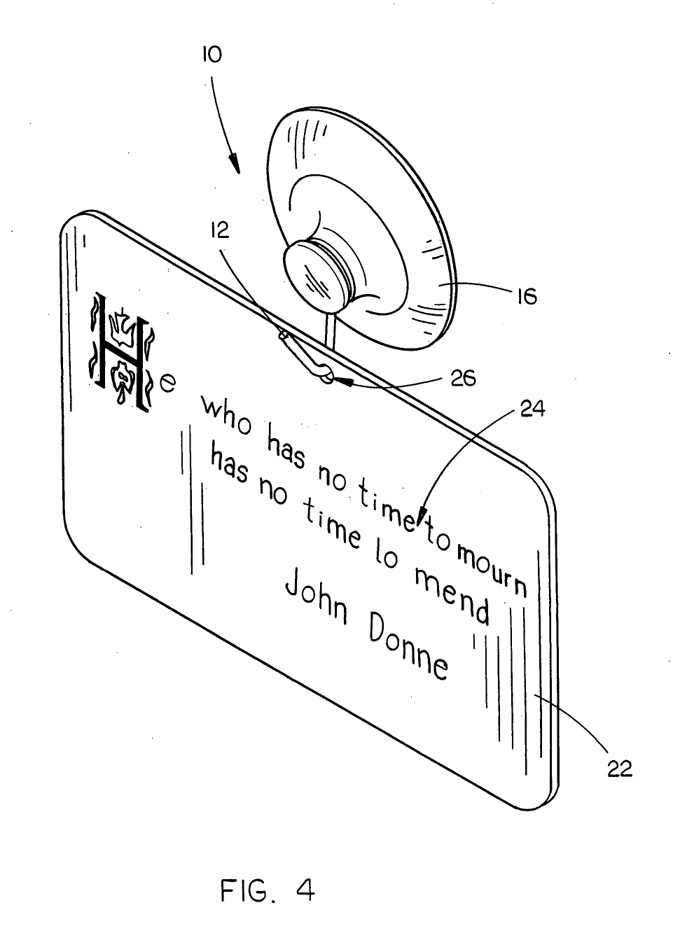

The greeting, inspirational and/or condolence quote card display system 10 of the present invention is shown best in FIGS. 1-4 as including a hanging hook 12, which in the preferred embodiment would be a metal J-shaped hook, which is mounted on and extends outwards from a securement device 14 which, in the preferred embodiment, would be a suction cup 16 or magnet (not shown) which will permit the hanging hook 12 to be releasably mounted on an object such as a refrigerator 50 for display of the quote cards included therewith. Also included with the present invention is a packet of generally planar, semi-rigid quote cards 20 which, in the preferred embodiment, would be constructed of generally rectangular sections of cardstock paper or the like having dimensions between three and five inches in length and between two and three inches in height, and would be laminated or coated with a protective plastic coating to increase longevity and render the quote cards generally waterproof. The packet of cards 20 would preferably include fifteen or so individual quote cards 22 each of which would have indicia 24 printed on one or both sides thereon, as shown best in FIGS. 3 and 4.

Each quote card 22 would include printed indicia 24 which exhibits a different word, phrase, and/or picture of inspirational sayings or the like in order to provide a variety of heartfelt, sympathetic, encouraging or inspiring expressions in a single collection, as shown in FIG. 2. In this manner, whichever phrase or saying resonates most strongly with the person receiving the greeting, inspirational and/or condolence quote card display system 10 of the present invention may be selected and displayed using the hanging hook 12 and securement device 14 in a desired location, as shown in FIG. 1. Display of the quote card 22 is performed by sliding the hanging hook 12 into the top center hole 26 formed on the quote card 22, as shown in FIG. 4, and then securing the securement device 14 on an appropriate object such as a refrigerator 50 for display of the quote card 22.

For example, as shown in FIG. 4, the quote card 22 is printed with indicia 24 which states that “He who has no time to mourn has no time to mend,” a quotation from John Donne. This quotation may resonate strongly with a person who has recently lost a loved one or close friend and remind them that it is acceptable and, in fact, preferable, to take time to grieve for the person who has passed on in order to facilitate the healing process. It should also be noted that many other sayings and slogans may be incorporated into the present invention, depending on the intended use of the present invention and also the intended audience.

As shown best in FIG. 3, the packet of quote cards 20, tied together with a ribbon 28, string or the like, and the hanging hook 12 mounted on securement device 14 would be placed within a carrying and packaging bag 30 for display, carrying and sale thereof. Although the exact nature of the carrying and packaging bag 30 is not critical to the present invention, it is preferred that the carrying and packaging bag 30 be of a tasteful and restrained design in order to facilitate use of the present invention in connection with presentation to persons who are in need of sympathy, encouragement and/or inspiration, and therefore it is expected that a bag constructed of fabric material would be well suited for use with the present invention. When each of the items are placed within the carrying and packaging bag 30, the completed package is substantially as shown in FIG. 2, and it is ready for sale and distribution.

It should be noted that although the example herein has been described as primarily designed for use with sympathy, encouragement and/or inspirational messages, the greeting, inspirational and/or condolence quote card display system 10 of the present invention may be used in virtually any desired message dissemination situation, such as displaying messages, birthday or other important celebratory events, and many other types of events and/or occurrences. One of the primary benefits of the present invention is that merely by changing the appearance of the quote cards 22 and changing the indicia 24 printed thereon, one may accommodate and recognize virtually any situation, therefore rendering the present invention almost universally useful. Furthermore, because the quote cards 22 are displayed in a user-selected location, i.e. by placing the securement device 14 on an appropriate object, the message or display indicia shown on the quote card 22 will be viewed by many more people than would be possible through use of a simple greeting card or the like. The messages and slogans used in connection with the present invention therefore can have greater impact on persons as a greater number of them will be able to view the indicia 24 printed on the quote card 22. This is a substantial improvement over greeting cards currently being distributed.

It is to be understood that numerous additions, modifications and substitutions may be made to the greeting, inspirational and/or condolence quote card display system 10 of the present invention which fall within the intended broad scope of the above description. For example, although the hanging hook 12 and securement device 14 have been described with some particularity, it should be noted that many different types of support and display devices may be used in connection with the present invention so long as the intended function of hanging the quote cards 22 in or on a selected object is maintained. Furthermore, the exact size, shape and construction materials used in connection with the quote cards 22 may be modified or changed depending on the desires of the manufacturer and user of the present invention, and may include shapes other than the rectangular one shown in the drawings in addition to construction materials such as plastic, metal or other such generally planar construction materials. Finally, it should be noted that the indicia 24 printed on the quote cards 22 may be modified or changed depending on the intentions of the manufacturer and user of the present invention to accommodate many different situations where use and display of the quote cards 22 of the present invention would be desirable.

There has therefore been shown and described a greeting, inspirational and/or condolence quote card display system 10 which accomplishes at least all of its intended objectives.

I claim:

1. A greeting, inspirational and condolence quote card display system comprising:
a hanging hook;
a hook securement device on which said hanging hook is mounted extending outwards therefrom, said hook securement device operative to releasably secure said hanging hook on a mounting object;
a plurality of generally planar quote cards each having a different one of at least one of greeting, inspirational and condolence message indicia displayed thereon;
each of said plurality of quote cards including at least one top hole formed extending therethrough, said at least one top hole adapted to receive said hanging hook therethrough to suspend each of said plurality of quote cards from said hanging hook upon said securement device being mounted on a mounting object; and
the front one of said plurality of quote cards being displayed via said hanging hook extending through said at least one top hole whereby said at least one of greeting, inspirational and condolence message indicia displayed thereon is visible to persons viewing said front one of said plurality of quote cards thereby providing said at least one of a greeting, inspirational and condolence message to the viewing person.

2. The greeting, inspirational and condolence quote card display system of claim 1 wherein said hanging hook is one of generally J-shaped and generally “?”-shaped.

3. The greeting, inspirational and condolence quote card display system of claim 1 wherein said hook securement device comprises a suction cup.

4. The greeting, inspirational and condolence quote card display system of claim 1 wherein said hook securement device comprises an adhesive mounting strip.

5. The greeting, inspirational and condolence quote card display system of claim 1 wherein each of said plurality of generally planar quote cards comprise a generally rectangular plastic-coated paper card on which said at least one of greeting, inspirational and condolence message indicia is imprinted thereon.

6. The greeting, inspirational and condolence quote card display system of claim 5 wherein said at least one top hole each of said plurality of generally planar quote cards comprises a top central hole through which said hanging hook extends to support each of said plurality of said quote cards thereon.

7. A greeting, inspirational and condolence quote card display system comprising:
a hanging hook;
a hook securement device on which said hanging hook is mounted extending outwards therefrom, said hook securement device operative to releasably secure said hanging hook on a mounting object;
a plurality of generally planar quote cards each having a different one of at least one of greeting, inspirational and condolence message indicia displayed thereon;
each of said plurality of quote cards including a top central hole formed extending therethrough, said top central hole adapted to receive said hanging hook therethrough to suspend each of said plurality of quote cards from said hanging hook upon said securement device being mounted on a mounting object; and
the front one of said plurality of quote cards being displayed via said hanging hook extending through said top central hole whereby said at least one of greeting, inspirational and condolence message indicia displayed thereon is visible to persons viewing said front one of said plurality of quote cards thereby providing said at least one of a greeting, inspirational and condolence message to the viewing person.
